(19) United States
(12) Patent Application Publication
(10) Pub. No.: US 2025/0334958 A1
(43) Pub. Date: Oct. 30, 2025

(54) METHOD FOR VERIFICATION OF THE FUNCTIONAL INTEGRITY OF A SAFETY CONTROLLER

(71) Applicant: Pilz GmbH & Co. KG, Ostfildern (DE)

(72) Inventor: Jochen BAUKNECHT, Ostfildern (DE)

(21) Appl. No.: 19/184,166

(22) Filed: Apr. 21, 2025

(30) Foreign Application Priority Data
Apr. 24, 2024 (DE) 102024111534.3

(51) Int. Cl. G05B 23/02

(52) U.S. Cl. CPC G05B 23/0216

(57) ABSTRACT

Described is a method for verifying the functional integrity of a safety controller that provides safety functions for one or more machines and has a central evaluation and control unit for operating the safety controller. The method comprises: powering on the safety controller; verifying a stored machine-readable instruction as to whether a commissioning test is to be executed; if verified, displaying information indicating that the commissioning test is to be executed; initiating a verification routine executable by the safety controller, the evaluation and control unit automatically verifying via the verification routine whether a user has successfully verified each of the safety functions; if all of the safety functions are successfully verified, deleting the machine-readable instruction that the commissioning test is to be executed; and if not all of the safety functions are successfully verified, storing the machine-readable instruction, indicating that the commissioning test is to be executed anew.

### CROSS REFERENCE TO RELATED APPLICATIONS

This application claims the benefit of priority from German application No. 10 2024 111 534.3 filed on Apr. 24, 2024, the entire contents of which are hereby incorporated by reference.

### TECHNICAL FIELD

The present disclosure relates to a method for verification of the functional integrity of a safety controller, which is configured to provide a number n≥1 of safety functions for a machine or a technical system with a plurality of machines and has a central evaluation and control unit for operating the safety controller.

### BACKGROUND

Safety controllers that comply with the international standard IEC 61508 are known in various embodiments from the state of the art. The main purpose of such safety controllers is, in particular, in the event of the occurrence of a hazardous situation, to safely switch over technical systems or machines in a fail-safe manner to a state that is safe for humans by providing appropriate safety functions. For this purpose, corresponding input signals from signal transmitters or signaling devices, which may be, for example, emergency shut-off switches, emergency stop switches, light grids, light curtains, pressure mats, safety gate position switches, 3D laser scanners, safety cameras, sensors, etc., are received and safely evaluated on the input side by a number of safety inputs. On the output side, corresponding safety outputs of an output circuit are activated. When a hazardous situation occurs, these safety outputs are used within the output circuit to control actuators, such as contactors, valves, etc., using output signals such that the machines connected to these actuators in the output circuit can be switched over to a state that is safe for people.

The basic functions, in particular the safety functions, of a safety controller can be defined by a corresponding programming of the safety controller. A corresponding operating program, which is executed by the evaluation and control unit during operation of the safety controller, is stored in a retrievable manner in a non-volatile storage device. The operating program is usually pre-programmed by the manufacturer of the safety controller so that the safety controller can be put into operation at the place of use. The operating program comprises, in particular, program code via which the hardware components of the safety controller can be addressed directly.

A programmable safety controller also enables the user, for example, to adapt the logical links of the input signals to the specific requirements, in particular safety requirements, via a user program. A programmable safety controller configured in this way comprises an operating program for this purpose, which operating program is separate from the user program and defines the basic functional scope of the safety controller. Safety-related control rules are, moreover, usually also implemented in the operating program, which control rules the user can consult with his user program, for example, in the form of predefined function modules, and parameterize with the input and output signals of the safety controller. By way of example, the operating program can contain predefined function modules for the fail-safe evaluation of a two-channel emergency shut-off button or a two-channel safety gate. In the user program, the user solely needs to specify how the prepared modules, in this case the emergency shut-off button and the safety gate, should be logically linked to each other.

In addition, the safety controllers known from the state of the art also enable manual hardware settings to be made in order to adjust certain operating parameters without needing to reprogram the operating program. These changeable operating parameters include, in particular, powering-on delays or powering-off delays of the safety outputs. Physical adjustment elements, such as potentiometers and/or DIP switches, are provided so that these hardware settings can be made by a user.

After the initial installation of a safety controller at the operating location or alternatively after a modified programming of the safety controller operating program, a commissioning test of the safety controller must first be executed before starting productive operation. With the assistance of the commissioning test, it is verified whether or not the safety controller can actually execute all the safety functions implemented in it. In other words, the commissioning test verifies whether functional integrity of the safety controller is given.

From the point of view of the manufacturer, the execution of a commissioning test by the user is required. Alas, it is ultimately not possible to verify whether or not the user has actually executed this prescribed commissioning test before the safety controller goes into productive operation for the first time after manufacture or after a change of the operating program. In the event that the commissioning test is not executed, which is in contrast with the instructions of the manufacturer, the problem may arise that the safety controller cannot execute the safety functions implemented in it, or can only execute them in an inadequate manner.

The disclosed system therefore provides a method for verification of the functional integrity of a safety controller, by which it can be verified whether the prescribed commissioning test has actually been executed by a user before the commencement of productive operation.

### SUMMARY

A method according to the invention for verification of the functional integrity of a safety controller, which is configured to provide a number n≥1 of safety functions for a machine or a technical system with a plurality of machines and has a central evaluation and control unit for operating the safety controller, comprises the following steps:
a) powering on of the safety controller,
b) verification of a machine-readable instruction stored in a non-volatile storage device of the safety controller as to whether a commissioning test is to be executed, by the evaluation and control unit, by a user of the safety controller; if no, then end of the method, if yes, then continue with method step c),
c) visualization of the information that the commissioning test is to be executed with the assistance of a display device of the safety controller,
d) starting of a verification routine that is executable by the safety controller, by which routine the evaluation and control unit automatically verifies whether the user has successfully verified, within a predefined or predefinable period of time, each of the safety functions from the number n≥1 of safety functions provided by the safety controller through the triggering of the relevant safety function,
e) deletion of the instruction, from the non-volatile storage device, that the commissioning test is to be executed if in method step d) all safety functions from the number n≥1 of safety functions of the safety controller provided have been successfully verified, or
f) storing of the instruction, in the non-volatile storage device, that the commissioning test is to be executed anew if not all safety functions were successfully verified in method step d).

A method according to the disclosure makes it possible to verify the functional integrity of a safety controller by advantageously ensuring that the mandatory commissioning test of the safety controller prescribed by the manufacturer has been successfully executed at least after the initial installation at the place of use, and preferably also after each modification to the operating program. In this context, “successful execution” or “successful verification” are understood to mean that the verification of all n≥1 safety functions provided has even taken place and that all tests have led to the desired result with regard to the safety functions. Only then can it be assumed that the functional integrity of the safety controller is actually given.

If it is determined during the method that the commissioning test has already been successfully executed, the functional integrity of the safety controller is ensured and the method is terminated. The safety controller can then work in productive operation.

If it is, however, determined that the commissioning test has not yet been successfully executed or has not yet been fully executed, the user is prompted to execute the commissioning test. When the commissioning test is then successfully executed and in method step e) the instruction that the commissioning test is to be executed is deleted from the non-volatile storage device, the functional integrity of the safety controller is given so that it can work in productive operation.

In one embodiment, the verification routine in method step d) is automatically started by the evaluation and control unit. This means that no user intervention is required to start the verification routine.

In an alternative embodiment, it is also possible that the verification routine in method step d) is started by an operator input from the user. By way of example, the operator input can be made by a change in the rotary position of a potentiometer of the safety controller, by actuating a physical switching element of the safety controller or by remote control.

In an advantageous embodiment, it is proposed that the safety controller is automatically powered off after the execution of method step f). After the safety controller is newly powered on, the user is then prompted to execute the commissioning test anew, since the machine-readable instruction that the commissioning test is to be executed is still stored in the non-volatile storage device.

In an alternative embodiment, it is possible that the safety controller is automatically switched over to a stop state after the execution of method step f), in which the safety controller remains powered on but does not provide any of the safety functions. Preferably, the information that the commissioning test is to be executed is visualized in the stop state of the safety controller with the assistance of the display device of the safety controller.

In one embodiment, it is proposed that the verification routine in method step d) is started anew in the stop state of the safety controller by an operator input from the user. By way of example, the operator input can be made by a change in the rotary position of a potentiometer of the safety controller, by actuating a physical switching element of the safety controller or by remote control.

In one embodiment, it is provided that the maximum time period for the triggering of all safety functions of the safety controller is set to a defined value. This results in a maximum permissible time period for the entire commissioning test. If this maximum permissible time period is exceeded, the commissioning test is aborted and must be executed anew by the user.

In a further embodiment, it is possible that the maximum time period for triggering each individual safety function of the safety controller is set to an individually defined value. This then results in a maximum permissible time period for triggering each individual safety function. If this maximum permissible time period for triggering one of the safety functions is exceeded, the commissioning test is aborted and must be executed anew by the user.

In order to ensure that the commissioning test is executed not only after the initial installation, but also at a later time after the safety controller operating program has been modified or reprogrammed, it is proposed in a particularly advantageous embodiment that before method step b) is executed, the evaluation and control unit reads out machine-readable information from the non-volatile storage device as to whether the operating program has been changed since the commissioning test was last executed. This machine-readable information can be, in particular, time information that indicates when the operating program was last changed and thus forms a kind of “time stamp” of the operating program, or other information relating to the version of the operating program. If the verification shows that the operating program has been changed, the machine-readable instruction that a commissioning test is to be executed by a user of the safety controller is stored in the non-volatile storage device of the safety controller. The method is subsequently continued with method step b).

### BRIEF DESCRIPTION OF THE DRAWINGS

Further features and advantages of an example embodiment example are described below with reference to the drawings.

FIG. 1 shows a highly simplified schematic representation of a safety controller.

FIG. 2 shows a schematic representation illustrating the basic sequence of a method for verification of the functional integrity of the safety controller shown in FIG. 1.

### DETAILED DESCRIPTION

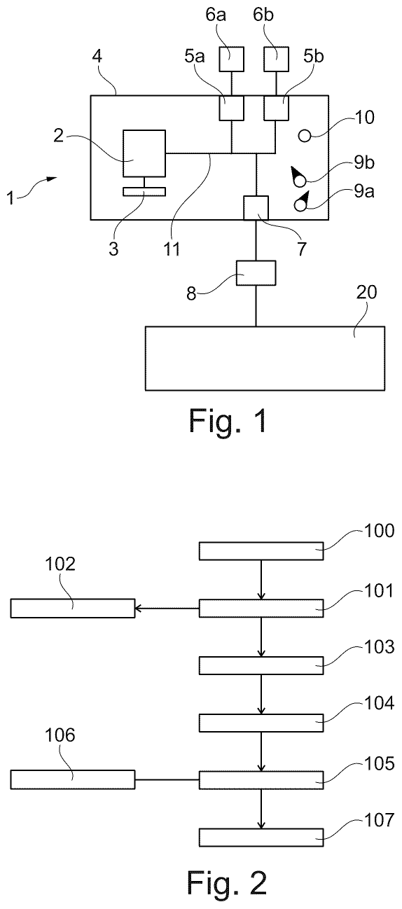

With reference to FIG. 1, a safety controller 1, which is configured to provide a number n≥1 of safety functions for a machine 20 or a technical system with a plurality of machines, has one central evaluation and control unit 2 for operating the safety controller 1. The central evaluation and control unit 2 is processor-based and may, for example, comprise at least one microcontroller. Preferably, the central evaluation and control unit 2 has a redundant configuration and thus comprises two microcontrollers. This ensures that the central evaluation and control unit 2 remains functional even if one of the two microcontrollers exhibits a defect.

The safety controller 1 moreover comprises a non-volatile storage device 3, in which, among other things, an operating program, which is executed by the central evaluation and control unit 2 during operation of the safety controller 1, is stored in a retrievable manner. After the powering on of the safety controller 1, the operating program is loaded into a volatile storage device, in particular a RAM storage, of the evaluation and control unit 2, which is not explicitly shown here, and is executed by this unit. The evaluation and control unit 2 and the non-volatile storage device 3 are accommodated in a housing 4 of the safety controller 1.

In this example embodiment, the safety controller 1 comprises two safety inputs 5a, 5b, each of which is configured to be redundant and therefore with two channels, and respectively two individual inputs. A signaling device 6a, 6b is connected to each of the safety inputs 5a, 5b prior to the initial commissioning of the safety controller 1. The types of signaling devices 6a, 6b involved depend, in particular, on the operating conditions of the machine 20 or technical system. Examples of such signaling devices 6a, 6b, which are expressly not to be understood as exhaustive, are emergency shut-off switches, emergency stop switches, light grids, light curtains, pressure mats, safety gate position switches, safety cameras or 3D laser scanners. Sensors that detect safety-critical physical measurement variables can also be used as signaling devices 6a, 6b.

In this embodiment example, the safety controller 1, moreover, comprises at least one safety output 7, which is likewise configured to be redundant and therefore with two channels and has two individual outputs. An actuator 8 is connected to this safety output 7, which in turn is connected to the machine 20 and thus interacts with the machine 20. The actuator 8 is configured, in the event of a hazardous situation occurring, to switch the machine 20 over into a state that is safe for the environment and in particular for people if the actuator 8 is activated accordingly by the safety controller 1. The actuator 8 can, for example, comprise at least one contactor or at least one valve. Preferably, the actuator 8 is likewise configured to be redundant. Safety controllers 1 frequently comprise a plurality of such safety outputs 7, to which a respective actuator 8 is connected, so that it is possible to connect a plurality of actuators 8 and therefore, in particular, a plurality of machines 2 to the safety controller 1.

The safety inputs 5a, 5b and the safety output 7 are in communication via a bus line 11 with the evaluation and control unit 2.

The safety controller 1, moreover, has a number of potentiometers 9a, 9b, by which certain functions of the safety controller 1, such as a powering-on delay or a powering-off delay of the safety output 7, can be parameterized by a user. By way of example, two potentiometers 9a, 9b are provided here. The safety controller 1, moreover, comprises one or more display devices 10, in particular one or a plurality of colored LEDs, by which the current operating status of the safety controller 1 can be visualized by corresponding light colors. Alternatively or additionally, it is also possible for a display device to be used as display device 10, by which information about the current operating status of the safety controller 1 and possibly further information can be displayed graphically and/or in text form.

In principle, it is possible to design the safety controller 1 in a modular way so that it comprises a plurality of function modules with corresponding safety inputs 5a, 5b and/or safety outputs 7.

If the safety controller 1 shown in FIG. 1 receives a signal from one of the signaling device 6a, 6b during productive operation that a hazardous situation exists, the actuator 8 connected to the safety output 5a, 5b in the output circuit is controlled in a fail-safe manner so that the machine 20 is powered off or alternatively otherwise switched over to a state that is safe for people. If the actuator 8, for example, comprises at least one contactor, a power-off signal is generated so that no control current still flows through the solenoid coil of the contactor. This has as a result that the switching contacts of the contactor are opened and the machine 20 connected to it is de-energized (which is to say, an emergency shut-off of the machine 20). From a functional point of view, the safety controller 1 then forms a safety switching device that supplies a switching output signal (in this case a switch-off signal). In principle, the safety controller 1 can also be configured such that it can also generate output signals other than just switching output signals.

After the initial installation of safety controller 1 at the operating location or alternatively after changing the programming of the operating program of safety controller 1, it is necessary to execute a commissioning test before the beginning of the productive operation. This commissioning test serves to verify whether the safety controller 1 can actually execute all the safety functions implemented in it with the desired/required result. In other words, the commissioning test verifies whether the safety controller 1 has the functional integrity that allows the safety controller 1 to be used in productive operation.

From the point of view of the manufacturer of the safety controller 1, the user is required to execute such a commissioning test. It is, however, ultimately not possible to check whether this commissioning test was actually executed before the safety controller 1 went into productive operation for the first time after the initial installation or alternatively after a change of the operating program. If, contrary to the instructions of the manufacturer, the commissioning test is not executed, the problem may arise that the safety controller 1 may not be able to execute the safety functions implemented in it or can only execute them inadequately.

In order to remedy this problem, a method for verification of the functional integrity of the safety controller 1 is explained in more detail below with further reference to FIG. 2, by which method it can be ensured that the commissioning test required by the manufacturer has actually been successfully executed before the safety controller 1 can be used in productive operation.

The method for verification of the functional integrity of the safety controller 1, which is configured to provide a number n≥1 of safety functions for the machine 20 or the technical system with a plurality of machines 20, comprises the steps:
a) powering on 100 (and thereby activation) of the safety controller 1,
b) verification 101 of a machine-readable instruction stored in the non-volatile storage device 3 of the safety controller 1 as to whether a commissioning test is to be executed by a user of the safety controller 1, by the evaluation and control unit 2; if no, then end 102 of the method, if yes, then continue 103 with method step c),
c) visualization 104 of the information that the commissioning test is to be executed with the assistance of the display device 10 of the safety controller 1,
d) starting 105 of a verification routine that is executable by the safety controller 1, by which routine the evaluation and control unit 2 automatically verifies whether the user has successfully verified, within a predefined period of time, each of the safety functions from the number n≥1 of safety functions provided by the safety controller 1 through the triggering of the relevant safety function, and
e) deletion 106 of the instruction, from the non-volatile storage device, that the commissioning test is to be executed, if in method step d) all safety functions from the number n≥1 of safety functions of the safety controller 1 provided have been successfully verified, or else
f) storing 107 of the instruction, in the non-volatile storage device 3, that the commissioning test is to be executed anew if not all safety functions were successfully verified in method step d).

If it is determined during the method that the commissioning test has already been successfully executed, the functional integrity of safety controller 1 is ensured and the method is terminated. The safety controller 1 can then work without restriction in productive operation. However, if it is determined that the commissioning test has not yet been executed or has not yet been fully executed, the user is prompted to execute it anew before the safety controller 1 can work in productive operation.

In one embodiment of the method presented here, the verification routine in method step d) can be started automatically by the evaluation and control unit 2. In so doing, no additional user intervention is required to start the verification routine. In an alternative embodiment, it is also possible that the verification routine is started in method step d) by an operator input of the user. By way of example, the operator input can be made by a change in the rotary position of one of the potentiometers 9a, 9b of the safety controller 1, by actuating a physical switching element of the safety controller 1 or by remote control.

In one embodiment of the method, it is possible that the safety controller 1 is automatically powered off after the execution of method step f). After the safety controller 1 is newly powered on, the user is then prompted to execute the commissioning test anew, since the machine-readable instruction that the commissioning test is to be executed is still stored in the non-volatile storage device 3 of the safety controller 1.

In an alternative embodiment, it is possible that the safety controller 1 is automatically switched over to a stop state after the execution of method step f), in which state the safety controller 1 remains powered on but does not provide any of the safety functions. Preferably, the information that the commissioning test is to be executed is visualized in the stop state of the safety controller 1 with the assistance of the display device 10 of the safety controller 1.

In one embodiment, it is proposed that the verification routine in method step d) is started anew in the stop state of the safety controller 1 by an operator input from the user. By way of example, the operator input can be made by a change in the rotary position of one of the potentiometers 9a, 9b of the safety controller 1, by actuating a physical switching element of the safety controller 1 or by remote control.

In one embodiment, it is provided that the maximum time period for triggering all safety functions of the safety controller 1 is set to a defined value. This results in a maximum permissible time period for the entire commissioning test. If this maximum permissible time period is exceeded, the commissioning test is aborted and must be executed anew by the user. The machine-readable instruction that a commissioning test is to be executed by a user of the safety controller 1 remains stored in the non-volatile storage device 3.

In a further embodiment, it may be provided that the maximum time period for triggering each individual safety function of the safety controller 1 is set to an individually defined value. If this maximum permissible time period for triggering one of the safety functions is exceeded, the commissioning test is aborted and must be executed anew by the user. The machine-readable instruction that a commissioning test is to be executed by a user of the safety controller 1 remains stored in the non-volatile storage device 3.

In order to ensure that the commissioning test of the safety controller 1 is executed not only after the initial installation, but also at a later time after the safety controller 1 operating program has been modified, it is preferably provided that after the powering on 100 and before the execution of method step b), the evaluation and control unit 2 reads out machine-readable information from the non-volatile storage device 3 and evaluates accordingly whether the operating program has been changed since the commissioning test was last executed. This machine-readable information can be, in particular, time information that indicates when the operating program was last changed (which is to say, a type of “time stamp” of the operating program), or other, in particular tamper-proof, information relating to the version of the operating program.

If this verification executed by the evaluation and control unit 2 shows that the operating program has been changed, the machine-readable instruction that the commissioning test is to be executed by a user of the safety controller 1 is stored in the non-volatile storage device 3 of the safety controller 1. The method is subsequently continued with method step b).

The method hereabove makes it possible to verify the functional integrity of the safety controller 1 by advantageously ensuring that the mandatory commissioning test of the safety controller 1 prescribed by the manufacturer has been successfully executed at least after the initial installation and preferably also after each modification to the operating program. The method makes it possible to determine whether all the safety functions provided by the safety controller 1 have actually been verified and whether all the verifications were successful.

What is claimed is:

1. A method for verifying a functional integrity of a safety controller that is configured to provide n safety functions, where n≥1, for a machine or a technical system with a plurality of machines and has an evaluation and control unit for operating the safety controller, the method comprising:
a) powering on the safety controller;
b) verifying, via the evaluation and control unit, a machine-readable instruction stored in a non-volatile storage device of the safety controller as to whether a commissioning test is to be executed;
in response to verifying in b) that the commissioning test is to be executed:
c) displaying, via a display device of the safety controller, information indicating that the commissioning test is to be executed;
d) initiating a verification routine that is executable by the safety controller, the evaluation and control unit automatically verifying via the verification routine whether a user has successfully verified, within a predefined period of time, each of the n safety functions through triggering of the n safety functions;
e) in response to all of the n safety functions being successfully verified in d), deleting from the non-volatile storage device the machine-readable instruction that the commissioning test is to be executed; and
f) in response to not all of the n safety functions being successfully verified in d), storing in the non-volatile storage device the machine-readable instruction, indicating that the commissioning test is to be executed anew.

2. The method of claim 1, wherein the verification routine in d) is automatically initiated by the evaluation and control unit.

3. The method of claim 1, wherein the verification routine in d) is initiated by receipt of an operator input.

4. The method of claim 1, wherein the safety controller is automatically powered off after execution of f).

5. The method of claim 1, wherein the safety controller is automatically switched over to a stop state after execution of f) such that the safety controller remains powered on but does not provide any of the n safety functions.

6. The method of claim 5, wherein the information indicating that the commissioning test is to be executed is displayed on the display device in the stop state of the safety controller.

7. The method of claim 5, wherein the verification routine is initiated anew in the stop state of the safety controller.

8. The method of claim 1, wherein a maximum time period for triggering all n safety functions of the safety controller is set to a defined value.

9. The method of claim 1, wherein a maximum time period for triggering each of the n safety functions of the safety controller is set to an individually defined value.

10. The method of claim 1, wherein:
before b) is executed, the evaluation and control unit reads out machine-readable information from the non-volatile storage device as to whether an operating program of the safety controller has been changed since the commissioning test was last executed, the operating program comprising program code via which hardware components of the safety controller are addressable; and
in response to the operating program being changed, the machine-readable instruction that a commissioning test is to be executed is stored in the non-volatile storage device of the safety controller.
